(19) United States
(12) Patent Application Publication
(10) Pub. No.: US 2024/0014378 A1
(43) Pub. Date: Jan. 11, 2024

(54) POSITIVE ELECTRODE AND ELECTROCHEMICAL DEVICE

(71) Applicant: MURATA MANUFACTURING CO., LTD., Kyoto (JP)

(72) Inventors: Daisuke MORI, Kyoto (JP); Ryuhei MATSUMOTO, Kyoto (JP); Yuri NAKAYAMA, Kyoto (JP); Hideki KAWASAKI, Kyoto (JP)

(21) Appl. No.: 18/238,953

(22) Filed: Aug. 28, 2023

Related U.S. Application Data
(63) Continuation of application No. PCT/JP2022/009535, filed on Mar. 4, 2022.

(30) Foreign Application Priority Data
Apr. 2, 2021 (JP) 2021-063591

(51) Int. Cl. H01M 4/136; H01M 4/62

(52) U.S. Cl. CPC H01M 4/136; H01M 4/625; H01M 2004/028

(57) ABSTRACT

A positive electrode is provided and including sulfur and a carbon material, in which the carbon material includes a carbon black having a first specific surface area and a carbon black having a second specific surface area, and the first specific surface area is lower than the second specific surface area.

### CROSS REFERENCE TO RELATED APPLICATIONS

The present application is a continuation of PCT patent application no. PCT/JP2022/009535, filed on Mar. 4, 2022, which claims priority to Japanese patent application no. 2021-063591, filed on Apr. 2, 2021, the entire contents of which are incorporated herein by reference.

### BACKGROUND

The present application relates to a positive electrode and an electrochemical device.

Electrochemical devices include capacitors, air batteries, fuel cells, secondary batteries, and the like, and are used for various purposes. Such an electrochemical device includes a positive electrode and a negative electrode, and contains an electrolytic solution responsible for ion transport between the positive electrode and the negative electrode.

For example, as the electrode of the electrochemical device expressed by magnesium batteries, an electrode made of magnesium or an electrode including at least magnesium is provided (in the following, such an electrode is also referred to as an “electrode containing magnesium” or simply a “magnesium electrode”, and an electrochemical device using an electrode containing magnesium is also referred to as “a magnesium electrode-based electrochemical device”). Magnesium is more resource-rich and much inexpensive than lithium. In addition, magnesium generally has a large amount of electricity per unit volume that can be extracted by a redox reaction, and is highly safe when used in a secondary battery. Thus, magnesium batteries are drawing attention as a next-generation secondary battery to replace lithium ion batteries.

As a magnesium battery, for example, a magnesium-sulfur secondary battery has been known. The magnesium-sulfur secondary battery is a secondary battery including a negative electrode containing magnesium as a negative electrode active material and a positive electrode containing sulfur as a positive electrode active material.

The positive electrode generally contains not only sulfur as a positive electrode active material but also a conductive auxiliary agent.

As the conductive auxiliary agent, for example, carbon materials such as carbon black, carbon fibers, and carbon nanotubes are generally used.

### SUMMARY

The present application relates to a positive electrode and an electrochemical device.

Conventional positive electrodes and electrochemical devices still have problems to be overcome including, for example, the following problem.

When carbon black was used as the conductive auxiliary agent, a more sufficient discharging capacity (or discharging capacity efficiency) was not obtained.

The present application relates to providing, in an embodiment, a positive electrode and an electrochemical device having a more sufficiently excellent discharging capacity.

The present application, in an embodiment, relates to:
a positive electrode including sulfur and a carbon material,
in which the carbon material includes a carbon black having a first specific surface area and a carbon black having a second specific surface area, and the first specific surface area is lower than the second specific surface area; and
an electrochemical device including the positive electrode.

The positive electrode and the electrochemical device of the present disclosure include enhanced characteristics, for example, in discharging capacity according to an embodiment.

### BRIEF DESCRIPTION OF THE FIGURES

FIG. 1 is a conceptual diagram of an electrochemical device (particularly a battery) according to an embodiment of the present application.

FIG. 2 is a schematic sectional view of a magnesium secondary battery (cylindrical magnesium secondary battery) provided as an embodiment of the present application.

FIG. 3 is a schematic perspective view of a magnesium secondary battery (flat laminate film type magnesium secondary battery) provided as an embodiment of the present application.

FIG. 4 is a schematic sectional view of an electrochemical device provided as a capacitor in an embodiment of the present application.

FIG. 5 is a schematic sectional view of an electrochemical device provided as an air battery in an embodiment of the present application.

FIG. 6 is a schematic sectional view of an electrochemical device provided as a fuel cell in an embodiment of the present application.

FIG. 7 is a block diagram illustrating a circuit configuration example when a magnesium secondary battery provided as an embodiment of the present application is applied to a battery pack.

FIG. 8 includes views A to C, which are block diagrams illustrating the configurations of an electrically driven vehicle, an electric power storage system, and a power tool to which a magnesium secondary battery is applied as an embodiment of the present application, respectively.

FIG. 9 is a developed view schematically illustrating a battery produced in examples of the present description.

FIG. 10 is a graph illustrating measurement results of a battery prepared in Example A1.

### DETAILED DESCRIPTION

Hereinafter, a “positive electrode” and an “electrochemical device” of the present application will be described in further detail according to an embodiment. Although description will be made with reference to the drawings as necessary, the described contents are only schematically and exemplarily illustrated for the understanding of the present application, and the appearance, the dimensional ratio, and the like may be different from the actual ones.

In the present application, the term “electrochemical device” broadly means a device capable of extracting energy by utilizing electrochemical reactions. In a narrow sense, the “electrochemical device” in the present application means a device including a pair of electrodes and an electrolyte, and in particular, a device that is charged and discharged as ions move. Examples of the electrochemical device include a capacitor, an air battery, and a fuel cell as well as a secondary battery, which are merely examples.

The positive electrode of the present application is used for an electrochemical device. That is, the positive electrode described in the present specification corresponds to a positive electrode for a device capable of extracting energy by utilizing an electrochemical reaction. The positive electrode of the present application is suitable for use in a magnesium-sulfur secondary battery from the viewpoint of further improving the discharging capacity. The magnesium-sulfur secondary battery is a secondary battery including a negative electrode containing magnesium as a negative electrode active material and a positive electrode containing sulfur as a positive electrode active material. In the present specification, the discharging capacity is a discharging capacity per sulfur unit weight at the time of initial discharge. The higher the discharging capacity is, the more preferable it is.

The positive electrode of the present application is a so-called “sulfur electrode”, and is a positive electrode containing sulfur as a positive electrode active material and a carbon material as a conductive auxiliary agent. The positive electrode usually includes a positive electrode layer, and the positive electrode layer may contain sulfur and a carbon material.

Sulfur is not particularly limited as long as it is sulfur used as a positive electrode active material of an electrochemical device, and may be, for example, sulfur (S) such as S₈ and/or polymeric sulfur.

The carbon material includes carbon black (hereinafter, may be simply referred to as “low specific surface area carbon black”) having a first specific surface area and carbon black (hereinafter, may be simply referred to as “high specific surface area carbon black”) having a second specific surface area, wherein the first specific surface area is less than (that is, less than) the second specific surface area. When the positive electrode contains a combination of these carbon blacks, the discharging capacity is more sufficiently increased. Details of this mechanism are unknown, but it is conceivably based on the following mechanism. Use of a combination of a low specific surface area carbon black and a high specific surface area carbon black not only improves the dispersibility of the entire carbon black but also improves the dispersibility of sulfur components. As a result, it is considered that since the function and action of the sulfur component having high insulating properties as a positive electrode active material can be more sufficiently exhibited, the discharging capacity is sufficiently increased. When the positive electrode does not contain high specific surface area carbon black, the discharging capacity decreases. If the positive electrode does not contain one of the low specific surface area carbon black, when the positive electrode has a positive electrode current collector, adhesion to the positive electrode current collector is reduced, so that the positive electrode layer is peeled off, and as a result, the discharging capacity is reduced.

The low specific surface area carbon black is carbon black having a specific surface area lower than the specific surface area of the high specific surface area carbon black. The specific surface area (that is, the first specific surface area) of the low specific surface area carbon black may be usually 30 m²/g or more and 200 m²/g or less, and from the viewpoint of further improving the discharging capacity, the specific surface area is preferably 30 m²/g or more and 150 m²/g or less, more preferably 30 m²/g or more and 120 m²/g or less, and still more preferably 40 m²/g or more and 100 m²/g or less.

As the specific surface area of carbon black, a specific surface area in which a peak is located in a specific surface area distribution (for example, a specific surface area (horizontal axis)—amount (vertical axis) graph) is used. Although there is usually one peak in the specific surface area distribution, when there are two or more peaks, the specific surface area of carbon black is the specific surface area of the highest peak.

The specific surface area distribution of carbon black can be measured by, for example, a BET method or the like using a specific surface area/maximum distribution measuring device.

The shape of the low specific surface area carbon black is not particularly limited, but the carbon black preferably has a solid particle shape from the viewpoint of further improving the discharging capacity.

The low specific surface area carbon black is commercially available. Examples of commercially available products of low specific surface area carbon black include solid particle-shaped Denka black (Denka Company Limited) and Super P (Timcal).

The high specific surface area carbon black is carbon black having a specific surface area higher than the specific surface area of the low specific surface area carbon black. The specific surface area (that is, the second specific surface area) of the high specific surface area carbon black may be usually 800 m²/g or more and 1600 m²/g or less, and from the viewpoint of further improving the discharging capacity, the specific surface area is preferably 1000 m²/g or more and 1500 m²/g or less, more preferably 1100 m²/g or more and 1400 m²/g or less, and still more preferably 1200 m²/g or more and 1300 m²/g or less.

The shape of the high specific surface area carbon black is not particularly limited, but the carbon black preferably has a hollow particle shape from the viewpoint of further improving the discharging capacity.

When a specific surface area (that is, the first specific surface area) of the low specific surface area carbon black is SA (m²/g), the high specific surface area carbon black usually has a specific surface area (that is, the second specific surface area) of 10×SA (m²/g) or more and 50×SA (m²/g) or less, and from the viewpoint of further improving the discharging capacity, the high specific surface area carbon black preferably has a specific surface area of 10×SA (m²/g) or more and 30×SA (m²/g) or less, and more preferably has a specific surface area of 15×SA (m²/g) or more and 25×SA (m²/g) or less.

The high specific surface area carbon black is commercially available. Examples of a commercially available product of high specific surface area carbon black include Ketjen black (hollow particle shape).

The content of the high specific surface area carbon black is usually 5 wt % or more and 75 wt % or less with respect to the total amount of the low specific surface area carbon black and the high specific surface area carbon black, and from the viewpoint of further improving the discharging capacity, the content is preferably 5 wt % or more and 65 wt % or less, more preferably 10 wt % or more and 65 wt % or less, further preferably 10 wt % or more and 55 wt % or less, especially preferably 10 wt % or more and 50 wt % or less, more sufficiently preferably 15 wt % or more and 50 wt % or less, and most preferably 20 wt % or more and 50 wt % or less (particularly 30 wt % or more and 50 wt % or less).

The specific surface areas of the low specific surface area carbon black and the high specific surface area carbon black and the distribution thereof can be measured using a positive electrode taken out from an electrochemical device (for example, a secondary battery). For example, first, the electrochemical device is decomposed, and the positive electrode is taken out. Next, the positive electrode (particularly the positive electrode layer) is immersed in a solvent to dissolve the binder and sulfur. Thereafter, by measuring the specific surface area distribution of the residue (that is, carbon black), the specific surface areas of the low specific surface area carbon black and the high specific surface area carbon black, and the content thereof with respect to the total amount thereof can be calculated. The specific surface areas of the low specific surface area carbon black and the high specific surface area carbon black measured and calculated by such a method and the contents thereof with respect to the total amount thereof are respectively matched with the specific surface areas of the low specific surface area carbon black and the high specific surface area carbon black used at the time of production and the amounts thereof used with respect to the total amounts thereof used.

From the pore distribution measured in the method for measuring the content of low specific surface area carbon black or the like, the pore distribution of each of low specific surface area carbon black and high specific surface area carbon black can also be evaluated.

The content of the carbon material is usually 5 wt % or more and 70 wt % or less with respect to the total amount of sulfur and the carbon material, and is preferably 5 wt % or more and 60 wt % or less, more preferably 20 wt % or more and 60 wt % or less, still more preferably 40 wt % or more and 60 wt % or less from the viewpoint of increasing the output of the electrochemical device (particularly, increasing the battery capacity).

The content of each of the carbon material and sulfur with respect to the total amount of sulfur and the carbon material can be measured and calculated by the same method as the method for measuring the content of low specific surface area carbon black or the like except that the content of only sulfur is measured and calculated by dissolving sulfur after dissolving the binder. The contents of the carbon material and sulfur measured and calculated by such a method are respectively matched with the amounts of use of the carbon material and sulfur with respect to the total amount of sulfur and the carbon material at the time of production. When both (carbon material and sulfur) are simultaneously dissolved in the cleaning solvent, it is necessary to perform thermal analysis or elemental analysis by ICP.

The carbon material may include other carbon materials such as graphite, carbon fiber, and carbon nanotube. When the carbon material contains another carbon material, the total content of the carbon material containing the above another carbon material may be within the above range. As the carbon fiber, for example, a vapor growth carbon fiber (VGCF (registered trademark)) can be used. As the carbon nanotube, for example, a single-wall carbon nanotube (SWCNT) and/or a multi-wall carbon nanotube (MWCNT) such as a double-wall carbon nanotube (DWCNT), or the like can be used.

The positive electrode may contain a binder. Examples of the binder include one or more polymer resins selected from fluorine-based resins such as polyvinylidene fluoride (PVdF) and/or polytetrafluoroethylene (PTFE), polyvinyl alcohol (PVA)-based resins, styrene-butadiene copolymer rubber (SBR)-based resins, and carboxymethyl cellulose. A conductive polymer may be used as the binder. As the conductive polymer, for example, substituted or unsubstituted polyaniline, polypyrrole and polythiophene, and a (co)polymer formed of one or two components selected therefrom may be used.

The content of the binder in the positive electrode is not particularly limited, and may be, for example, 0.1 wt % or more and 20 wt % or less, or 1 wt % or more and 10 wt % or less with respect to the total amount of sulfur and the carbon material.

The positive electrode may further contain a conductive auxiliary agent other than the carbon material. As other conductive auxiliary agents, a metal material such as a Ni powder, and/or a conductive polymer material or the like can also be used.

The positive electrode (particularly the positive electrode layer) can be produced, for example, by the following method.

First, sulfur and low specific surface area carbon black are dry-mixed at a predetermined weight ratio using an agate mortar. To this mixture, high specific surface area carbon black is added at a predetermined weight ratio, and dry-mixing is performed with the agate mortar. Next, the obtained carbon-sulfur composite is added to a solvent together with a binder, and mixed with a pencil mixer to obtain a positive electrode slurry. The positive electrode slurry is applied onto the positive electrode current collector using a bar coater, subjected to vacuum drying at 10° C. or more and 50° C. or less for 6 hours or more and 24 hours or less, and then subjected to normal pressure drying at 50° C. or more and 80° C. or less for 10 minutes or more and 120 minutes or less.

The solvent of the positive electrode slurry is not particularly limited as long as the binder can be dissolved, and examples thereof include a monoalcohol such as methanol, ethanol, or propyl alcohol, or a mixed liquid of the monoalcohol and water.

The solid content concentration of the positive electrode slurry is not particularly limited, and is usually preferably 2 wt % or more and 80 wt % or less, and particularly preferably 5 wt % or more and 60 wt % or less.

In the present application, the negative electrode may be an electrode containing magnesium. The material constituting the negative electrode (specifically, the negative electrode active material) is preferably formed of magnesium metal alone, a magnesium alloy or a magnesium compound because of an “electrode containing magnesium”. When the negative electrode is made of a simple substance of magnesium (for example, magnesium plate or the like), a Mg purity of the simple substance is 90% or more, preferably 95% or more, and more preferably 98% or more. The negative electrode can be produced from, for example, a plate-like material or a foil-like material, but is not limited thereto, and can be formed (shaped) with the use of a powder.

The negative electrode may have a structure in which a negative electrode active material layer is formed in the vicinity of the surface the negative electrode. For example, the negative electrode may be a negative electrode having a layer with magnesium ion conductivity containing magnesium (Mg) and further containing at least any of carbon (C), oxygen (O), sulfur (S), and halogen as a negative electrode active material layer. Such a negative electrode active material layer may be one having a single peak derived from magnesium in the range of 40 eV or more and 60 eV or less, though this is merely an example. Examples of halogen include at least one selected from the group consisting of fluorine (F), chlorine (Cl), bromine (Br), and iodine (I). In such a case, the negative electrode active material layer may exhibit, over a region from its front surface to a depth of 2×10⁻⁷ m, a single peak derived from magnesium in the range of 40 eV or more and 60 eV or less. This is because in such a case, the negative electrode active material layer will exhibit good electrochemical activity over the region from the surface to the inside. In addition, for a similar reason, the oxidized state of magnesium may be substantially constant from its front surface to a depth of 2×10⁻⁷ m in the negative electrode active material layer. Here, a front surface of the negative electrode active material layer means a surface on a side constituting a front surface of the electrode of both surfaces of the negative electrode active material layer, and a back surface of the negative electrode active material layer means a surface on a side opposite to the front surface, that is, a surface on a side constituting an interface between a current collector and the negative electrode active material layer. Whether the negative electrode active material layer contains the elements mentioned above can be confirmed based on XPS (X-ray Photoelectron Spectroscopy) method. The fact that the negative electrode active material layer has the peak and the fact that the negative electrode active material layer has the oxidation state of magnesium can also be confirmed similarly based on the XPS method.

In the electrochemical device of the present application, the positive electrode and the negative electrode may be separated from each other by an inorganic or organic separator through which magnesium ions can pass, while preventing the occurrence of short circuit due to the contact between the positive electrode and the negative electrode. Examples of the inorganic separator include a glass filter and a glass fiber. Examples of the organic separator include porous membranes of synthetic resins including a polytetrafluoroethylene, a polypropylene, and/or a polyethylene, and the organic separator may have a structure obtained by stacking two or more of the membranes. Above all, a porous membrane made of a polyolefin is preferred, because the membrane has the excellent effect of short-circuit prevention and can make an improvement in the safety of the battery by the shutdown effect.

The electrolyte layer in the electrochemical device is formed of an electrolytic solution, and may further contain a polymer compound as a holder for holding the electrolytic solution. The electrolyte layer may be impregnated and disposed in the separator. The polymer compound may be swollen by the electrolytic solution. In this case, the polymeric compound swollen with the electrolytic solution may have a gel-like form. Examples of the polymeric compound include polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, and/or polycarbonate. Particularly, if the viewpoint of electrochemical stability is more important, the polymeric compound may be polyacrylonitrile, polyvinylidene fluoride, polyhexafluoropropylene, or polyethylene oxide. The electrolyte layer may be a solid-state electrolyte layer.

The electrolytic solution corresponds to an electrolyte for a device capable of extracting energy by utilizing an electrochemical reaction. As a major premise of the electrolytic solution, the electrolytic solution may be an electrolytic solution used for an electrochemical device including an electrode containing magnesium. In particular, the electrolytic solution may be an electrolytic solution for an electrochemical device including an electrode containing magnesium as a negative electrode.

In the electrochemical device, it is preferable that while the negative electrode is an electrode containing magnesium, the positive electrode is an electrode containing sulfur, that is, a sulfur electrode. That is, in a preferred aspect, the positive electrode of the present application is a positive electrode for magnesium (Mg)-sulfur (S) electrode.

The electrolytic solution contains at least a solvent and a magnesium salt. More specifically, the electrolytic solution contains a magnesium salt and a solvent for dissolving the salt. The solvent is not particularly limited as long as the magnesium salt can be dissolved, and from the viewpoint of further improving the discharging capacity, the solvent preferably contains an ether-based solvent, and more preferably contains only an ether-based solvent.

From the viewpoint of further improving the discharging capacity, the solvent preferably contains linear ether, and more preferably contains only linear ether. That is, it is preferable that ether having a linear structure (preferably, only the ether) in the molecule forms an electrolytic solution solvent rather than cyclic ether such as tetrahydrofuran. In short, it can be said that the solvent in the electrolytic solution is preferably a linear ether solvent.

The linear ether may be, for example, linear ether having an ethyleneoxy structural unit represented by the following general formula.

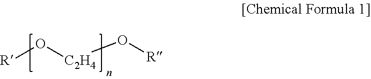

In the formula, R′ and R″ are each independently a hydrocarbon group having 1 or more and 10 or less carbon atoms, and n is an integer of 1 or more and 10 or less.

The linear ether solvent contains one or more ethyleneoxy structural units per molecule. The “ethyleneoxy structural unit” here refers to a molecular structural unit (—O—C₂H₄—) in which an ethylene group and an oxygen atom are bonded, and one or more such molecular structural units is included in a linear ether. For example, when one ethyleneoxy structural unit is contained, the linear ether solvent may be such a linear ether as dimethoxyethane/DME (ethylene glycol dimethyl ether) and/or diethoxyethane/DEE (ethylene glycol diethyl ether).

In a preferred aspect, the linear ether contains two or more molecular structural units (—O—C₂H₄—). In other words, it can be said that the linear ether in the electrolytic solution preferably has a structure in which two or more molecules of glycol are dehydration-condensed.

R′ and R″ in the above general formula of the linear ether each independently represent a hydrocarbon group. Thus, R′ and R″ may be each independently an aliphatic hydrocarbon group, an aromatic hydrocarbon group and/or an aromatic-aliphatic hydrocarbon group. Here, the “linear ether” in the present specification means that at least a site of the ethyleneoxy structural unit is not branched (that is, no branched structure is included). This means that R′ and R″ in the above general formula do not necessarily have to have a linear structure, but may have a branched structure. In a certain preferred aspect, the linear ether for use in the electrolytic solution is a glycol-based ether in which not only the site of the ethyleneoxy structural unit does not have a branched structure but also R′ and R″ have no branched structure. R′ and R″ are each independently preferably an aliphatic hydrocarbon group having 1 or more and 5 or less carbon atoms (particularly a saturated aliphatic hydrocarbon group), more preferably an aliphatic hydrocarbon group having 1 or more and 3 or less carbon atoms (particularly a saturated aliphatic hydrocarbon group) from the viewpoint of further improving the discharging capacity. From the viewpoint of further improving the discharging capacity, n is preferably an integer of 1 or more and 5 or less, more preferably an integer of 1 or more and 3 or less, and still more preferably an integer of 2 or more and 3 or less.

The linear ether having two or more ethyleneoxy structural units is not particularly limited, and examples thereof include diethylene glycol ether, triethylene glycol ether, tetraethylene glycol ether, pentaethylene glycol ether, and hexaethylene glycol ether. Similarly, the linear ether may be a heptaethylene glycol ether, an octaethylene glycol ether, a nonaethylene glycold ether, a decaethylene glycol ether, or the like, and more specifically, the linear ether may be a polyethylene glycol ether having more ethyleneoxy structural units.

In a certain suitable aspect of the linear ether in the present application, a hydrocarbon group having 1 or more and 10 or less carbon atoms is an aliphatic hydrocarbon group. In other words, with regard to the linear ether contained in the electrolytic solution, R′ and R″ in the general formula may be each independently an aliphatic hydrocarbon group of 1 or more and 10 or less. Although not particularly limited, examples thereof include ethylene glycol ether, diethylene glycol ether, triethylene glycol ether, tetraethylene glycol ether, pentaethylene glycol ether, and hexaethylene glycol ether as mentioned below. Similarly, the linear ether may be a heptaethylene glycol ether, an octaethylene glycol ether, a nonaethylene glycol ether, or a decaethylene glycol ether. The linear ether is preferably a diethylene glycol ether (particularly diethylene glycol dimethyl ether) from the viewpoint of further improving the discharging capacity.

### (Ethylene Glycol-Based Ether)

Ethylene glycol dimethyl ether, ethylene glycol ethyl methyl ether, ethylene glycol methyl propyl ether, ethylene glycol butyl methyl ether, ethylene glycol methyl pentyl ether, ethylene glycol methyl hexyl ether, ethylene glycol methyl heptyl ether, and ethylene glycol methyl octyl ether;

ethylene glycol diethyl ether, ethylene glycol ethyl propyl ether, ethylene glycol butyl ethyl ether, ethylene glycol ethyl pentyl ether, ethylene glycol ethyl hexyl ether, ethylene glycol ethyl heptyl ether, and ethylene glycol ethyl octyl ether;

ethylene glycol dipropyl ether, ethylene glycol butyl propyl ether, ethylene glycol propyl pentyl ether, ethylene glycol propyl hexyl ether, ethylene glycol propyl heptyl ether, and ethylene glycol propyl octyl ether;

ethylene glycol dibutyl ether, ethylene glycol butyl pentyl ether, ethylene glycol butyl hexyl ether, ethylene glycol butyl heptyl ether, and ethylene glycol butyl octyl ether;

ethylene glycol dipentyl ether, ethylene glycol hexylpentyl ether, ethylene glycol heptylpentyl ether, and ethylene glycol octylpentyl ether;

ethylene glycol dihexyl ether, ethylene glycol heptylhexyl ether, and ethylene glycol hexyloctyl ether;

ethylene glycol diheptyl ether and ethylene glycol heptyl octyl ether; and

ethylene glycol dioctyl ether

### (Diethylene Glycol-Based Ether)

diethylene glycol dimethyl ether, diethylene glycol ethyl methyl ether, diethylene glycol methyl propyl ether, diethylene glycol butyl methyl ether, diethylene glycol methyl pentyl ether, diethylene glycol methyl hexyl ether, diethylene glycol methyl heptyl ether, and diethylene glycol methyl octyl ether;

diethylene glycol diethyl ether, diethylene glycol ethylpropyl ether, diethylene glycol butyl ethyl ether, diethylene glycol ethylpentyl ether, diethylene glycol ethylhexyl ether, diethylene glycol ethyl heptyl ether, and diethylene glycol ethyl octyl ether;

diethylene glycol dipropyl ether, diethylene glycol butyl propyl ether, diethylene glycol propylpentyl ether, diethylene glycol propyl hexyl ether, diethylene glycol propyl heptyl ether, and diethylene glycol propyl octyl ether;

diethylene glycol dibutyl ether, diethylene glycol butyl pentyl ether, diethylene glycol butylhexyl ether, diethylene glycol butyl heptyl ether, and diethylene glycol butyl octyl ether;

diethylene glycol dipentyl ether, diethylene glycol hexylpentyl ether, diethylene glycol heptylpentyl ether, and diethylene glycol octylpentyl ether;

diethylene glycol dihexyl ether, diethylene glycol heptylhexyl ether, and diethylene glycol hexyloctyl ether;

diethylene glycol diheptyl ether and diethylene glycol heptyl octyl ether; and

diethylene glycol dioctyl ether

### (Triethylene Glycol-Based Ether)

triethylene glycol dimethyl ether, triethylene glycol ethyl methyl ether, triethylene glycol methyl propyl ether, triethylene glycol butyl methyl ether, triethylene glycol methyl pentyl ether, triethylene glycol methyl hexyl ether, triethylene glycol methyl heptyl ether, and triethylene glycolmethyloctyl ether;

triethylene glycol diethyl ether, triethylene glycol ethylpropyl ether, triethylene glycol butyl ethyl ether, triethylene glycol ethylpentyl ether, triethylene glycol ethylhexyl ether, triethylene glycol ethyl heptyl ether, and triethylene glycol ethyl octyl ether;

triethylene glycol dipropyl ether, triethylene glycol butylpropyl ether, triethylene glycol propylpentyl ether, triethylene glycol propylhexyl ether, triethylene glycol propyl heptyl ether, and triethylene glycol propyl octyl ether;

triethylene glycol dibutyl ether, triethylene glycol butyl pentyl ether, triethylene glycol butylhexyl ether, triethylene glycol butyl heptyl ether, and triethylene glycol butyl octyl ether;

triethylene glycol dipentyl ether, triethylene glycol hexylpentyl ether, triethylene glycol heptylpentyl ether, and triethylene glycol octylpentyl ether;

triethylene glycol dihexyl ether, triethylene glycol heptylhexyl ether, and triethylene glycol hexyloctyl ether;

triethylene glycol diheptyl ether and triethylene glycol heptyl octyl ether; and

triethylene glycol dioctyl ether

### (Tetraethylene Glycol-Based Ether)

Tetraethylene glycol dimethyl ether, tetraethylene glycol ethyl methyl ether, tetraethylene glycol methyl propyl ether, tetraethylene glycol butyl methyl ether, tetraethylene glycol methyl pentyl ether, tetraethylene glycol methyl hexyl ether, tetraethylene glycol methyl heptyl ether, and tetraethylene glycolmethyloctyl ether;

tetraethylene glycol diethyl ether, tetraethylene glycol ethylpropyl ether, tetraethylene glycol butyl ethyl ether, tetraethylene glycol ethylpentyl ether, tetraethylene glycol ethylhexyl ether, tetraethylene glycol ethyl heptyl ether, and tetraethylene glycol ethyl octyl ether;

tetraethylene glycol dipropyl ether, tetraethylene glycol butylpropyl ether, tetraethylene glycol propylpentyl ether, tetraethylene glycol propylhexyl ether, tetraethylene glycol propyl heptyl ether, and tetraethylene glycol propyl octyl ether;

tetraethylene glycol dibutyl ether, tetraethylene glycol butyl pentyl ether, tetraethylene glycol butylhexyl ether, tetraethylene glycol butyl heptyl ether, and tetraethylene glycol butyl octyl ether;

tetraethylene glycol dipentyl ether, tetraethylene glycol hexylpentyl ether, tetraethylene glycol heptylpentyl ether, and tetraethylene glycol octylpentyl ether;

tetraethylene glycol dihexyl ether, tetraethylene glycol heptylhexyl ether, and tetraethylene glycol hexyloctyl ether;

tetraethylene glycol diheptyl ether and tetraethylene glycol heptyloctyl ether; and

tetraethylene glycol dioctyl ether

### (Pentaethylene Glycol-Based Ether)

pentaethylene glycol dimethyl ether, pentaethylene glycol ethyl methyl ether, pentaethylene glycol methyl propyl ether, pentaethylene glycol butyl methyl ether, pentaethylene glycol methyl pentyl ether, pentaethylene glycol methyl hexyl ether, pentaethylene glycol methyl heptyl ether, and pentaethylene glycolmethyloctyl ether;

pentaethylene glycol diethyl ether, pentaethylene glycol ethylpropyl ether, pentaethylene glycol butyl ethyl ether, pentaethylene glycol ethylpentyl ether, pentaethylene glycol ethylhexyl ether, pentaethylene glycol ethyl heptyl ether, and pentaethylene glycol ethyl octyl ether;

pentaethylene glycol dipropyl ether, pentaethylene glycol butylpropyl ether, pentaethylene glycol propylpentyl ether, pentaethylene glycol propylhexyl ether, pentaethylene glycol propyl heptyl ether, and pentaethylene glycol propyl octyl ether;

pentaethylene glycol dibutyl ether, pentaethylene glycol butyl pentyl ether, pentaethylene glycol butylhexyl ether, pentaethylene glycol butyl heptyl ether, and pentaethylene glycol butyl octyl ether;

pentaethylene glycol dipentyl ether, pentaethylene glycol hexylpentyl ether, pentaethylene glycol heptylpentyl ether, and pentaethylene glycol octylpentyl ether;

pentaethylene glycol dihexyl ether, pentaethylene glycol heptylhexyl ether, and pentaethylene glycol hexyl octyl ether;

pentaethylene glycol diheptyl ether and pentaethylene glycol heptyl octyl ether; and

pentaethylene glycol dioctyl ether

### (Hexaethylene Glycol-Based Ether)

hexaethylene glycol dimethyl ether, hexaethylene glycol ethyl methyl ether, hexaethylene glycol methyl propyl ether, hexaethylene glycol butyl methyl ether, hexaethylene glycol methyl pentyl ether, hexaethylene glycol methyl hexyl ether, hexaethylene glycol methyl heptyl ether, and hexaethylene glycolmethyloctyl ether;

hexaethylene glycol diethyl ether, hexaethylene glycol ethylpropyl ether, hexaethylene glycol butyl ethyl ether, hexaethylene glycol ethylpentyl ether, hexaethylene glycol ethylhexyl ether, hexaethylene glycol ethyl heptyl ether, and hexaethylene glycol ethyl octyl ether;

hexaethylene glycol dipropyl ether, hexaethylene glycol butylpropyl ether, hexaethylene glycol propylpentyl ether, hexaethylene glycol propylhexyl ether, hexaethylene glycol propyl heptyl ether, and hexaethylene glycol propyl octyl ether;

hexaethylene glycol dibutyl ether, hexaethylene glycol butyl pentyl ether, hexaethylene glycol butylhexyl ether, hexaethylene glycol butyl heptyl ether, and hexaethylene glycol butyl octyl ether;

hexaethylene glycol dipentyl ether, hexaethylene glycol hexylpentyl ether, hexaethylene glycol heptylpentyl ether, and hexaethylene glycol octylpentyl ether;

hexaethylene glycol dihexyl ether, hexaethylene glycol heptylhexyl ether, and hexaethylene glycol hexyl octyl ether;

hexaethylene glycol diheptyl ether and hexaethylene glycol heptyl octyl ether; and

hexaethylene glycol dioctyl ether

Similarly, the linear ether may be a heptaethylene glycol ether, an octaethylene glycol ether, a nonaethylene glycol ether, a decaethylene glycol ether, or the like, and more specifically, the linear ether may be a polyethylene glycol ether.

Examples of such a magnesium salt contained in the electrolytic solution include a salt having the general formula MgXₙ (where n is 1 or 2 and X is a monovalent or divalent anion). When X is a halogen (F, Cl, Br, or I), such a magnesium salt forms a metal halide salt. X may be another anion and in such a case, the magnesium salt is, for example, at least one magnesium salt selected from the group consisting of magnesium perchlorate (Mg(ClO₄)₂), magnesium nitrate (Mg(NO₃)₂), magnesium sulfate (MgSO₄), magnesium acetate (Mg(CH₃COO)₂), magnesium trifluoroacetate (Mg(CF₃COO)₂), magnesium tetrafluoroborate (Mg(BF₄)₂), magnesium tetraphenylborate (Mg(B(C₆H₅)₄)₂), magnesium hexafluorophosphate (Mg(PF₆)₂), magnesium hexafluoroarsenate (Mg(AsF₆)₂), magnesium salt of perfluoroalkylsulfonic acid ((Mg(R_{f1}SO₃)₂), wherein R_{f1} is a perfluoroalkyl group), magnesium salt of perfluoroalkylsulfonylimide (Mg((R_{f2}SO₂)₂N)₂, wherein R_{f2} is a perfluoroalkyl group), and magnesium salt of hexaalkyldisilazide ((Mg(HRDS)₂), wherein R is an alkyl group).

Among the above, from the viewpoint of further improving the discharging capacity, at least one of halogen-based salts and imide-based salts is particularly preferable as the magnesium salt. That is, in the ether-based solvent (particularly, linear ether), the magnesium salt may be a halogen metal salt or an imide metal salt, or a combination of a halogen metal salt and an imide metal salt. This means that at least one type of halogen metal salt or imide metal salt is, as the magnesium salt, in a state of being dissolved in the ether-based solvent (particularly the linear ether). In a preferred aspect, an imide metal salt may be further added in addition to the halogen metal salt in an ether-based solvent (particularly, a linear ether), whereby a higher discharging capacity can be obtained more effectively.

Examples of the metal halide salt include at least one kind selected from the group consisting of magnesium fluoride (MgF₂), magnesium chloride (MgCl₂), magnesium bromide (MgBr₂), and magnesium iodide (MgI₂). Among them, magnesium chloride is preferably used as a halogen metal salt. That is, magnesium chloride (MgCl₂) is preferable as the magnesium salt combined with the ether-based solvent (particularly the linear ether). This is because in such magnesium chloride (MgCl₂), high discharging capacity is easily achieved in the electrochemical device.

The metal imide salt is a magnesium salt having an imide as a molecular structure. Preferably, the metal imide salt is a magnesium salt having a sulfonylimide as its molecular structure. This is because in a magnesium salt having a sulfonylimide as a molecular structure, a higher discharging capacity is easily achieved in an electrochemical device. In one preferred aspect, the magnesium salt containing a sulfonyl imide as a molecular structure is, together with the halogen metal salt (for example, magnesium chloride), capable of contributing to the achievement of a higher discharging capacity by the electrochemical device.

The imide metal salt is preferably a magnesium salt of perfluoroalkylsulfonylimide. That is, the imide metal salt is preferably Mg((R_{f}SO₂)₂N)₂ (in the formula, R_{f}: perfluoroalkyl group). For example, R_{f} may be a perfluoroalkyl group having 1 or more and 10 or less carbon atoms, a perfluoroalkyl group having 1 or more and 8 or less carbon atoms, a perfluoroalkyl group having 1 or more and 6 or less carbon atoms, a perfluoroalkyl group having 1 or more and 4 or less carbon atoms, a perfluoroalkyl group having 1 or more and 3 or less carbon atoms, or a perfluoroalkyl group having 1 or more and 2 or less carbon atoms. As one example, the imide metal salt may be magnesium bis(trifluoromethanesulfonyl)imide, namely, Mg(TFSI)₂. The Mg(TFSI)₂ allows the electrochemical device to easily achieve higher discharging capacity. In a preferred aspect, Mg(TFSI)₂ is, together with the halogen metal salt (particularly, magnesium chloride (MgCl₂)), capable of particularly promoting the achievement of higher discharging capacity by the electrochemical device.

The content of the magnesium salt may be, for example, 10 M or less (particularly, more than 0 M and 10 M or less) (based on the entire electrolytic solution), and from the viewpoint of further improving the discharging capacity, may be preferably 0.2 M or more and 5 M or less (based on the entire electrolytic solution), and more preferably 1 M or more and 2 M or less (based on the entire electrolytic solution). When the electrolytic solution contains two or more kinds of magnesium salts, the total content thereof may be within the above range. In particular, when the electrolytic solution contains both a halogen metal salt and an imide metal salt as magnesium salts, the contents of the halogen metal salt and the imide metal salt may be each independently, for example, 5 M or less (particularly, more than 0 M and 5 M or less) (based on the entire electrolytic solution), and from the viewpoint of further improving the discharging capacity, the contents may be preferably 0.1 M or more and 2.5 M or less (based on the entire electrolytic solution), and more preferably 0.3 M or more and 1 M or less (based on the entire electrolytic solution).

The electrolytic solution may further contain a cyclic organic compound having a two-dimensional structure or a three-dimensional structure. Such a cyclic organic compound is added to an electrolytic solution solvent as an additive. That is, the “cyclic organic compound having a two-dimensional structure or a three-dimensional structure” is contained as a secondary component with respect to an ether-based solvent containing a magnesium salt, particularly a linear ether solvent. When the charge liquid contains such a cyclic organic compound, the higher discharging capacity can be obtained.

In the present application, the discharging capacity can be more improved due to the inclusion of the “cyclic organic compound having a two-dimensional structure or a three-dimensional structure” in the ether-based solvent of the electrolytic solution. In particular, when the “cyclic organic compound having a two-dimensional structure or a three-dimensional structure” is added to a linear ether containing a magnesium salt, the discharging capacity can be more significantly improved.

The “cyclic organic compound having a two-dimensional structure or a three-dimensional structure” broadly refers to a substance having a molecular structure in which rings are connected in a two-dimensional plane, or a substance having a molecular structure in which rings are three-dimensionally connected. In a narrow sense, the “cyclic organic compound having a two-dimensional structure” means an organic substance having a cyclic molecular structure so as to form a fused ring, and the “cyclic organic compound having a three-dimensional structure” means an organic substance having a network of cyclic molecules in a three-dimensional shape. A typical “cyclic organic compound having a three-dimensional structure” is fullerene.

In a preferred aspect, the “cyclic organic compound having a two-dimensional structure or a three-dimensional structure” is a fused ring compound. That is, the cyclic organic compound is an organic substance having a molecular structure obtained as a result that two or more monocyclic rings supply their ring sides to each other. In the cyclic organic compound having a two-dimensional structure, a two-dimensional planar molecular structure may be formed so that two or more monocyclic rings share their ring sides with each other. In such a case, the two-dimensional planar molecular structure may be a linear fused ring type, a wing-like fused ring type, or the like. Similarly, in the cyclic organic compound having a three-dimensional structure, a three-dimensional molecular structure may be formed so that two or more monocyclic rings share their ring sides with each other.

The form of each ring in the fused ring compound may be a three-membered ring, a four-membered ring, a five-membered ring, a six-membered ring, a seven-membered ring or an eight-membered ring, and a combination thereof may be included as a whole of the fused ring compound. A monocyclic structure in the fused ring compound is not limited to an isocyclic ring, and may be a heterocyclic ring, or may be a combination thereof. The number of rings in the fused ring compound is not particularly limited.

The number of rings in the fused ring compound may be 40 or less, 30 or less or 20 or less, preferably 15 or less, and more preferably 10 or less. The lower limit of the number of such rings is not particularly limited, and is, for example, 2. In a preferred aspect, the number of rings in the fused ring compound is 2 to 8 or 2 to 7, for example 2 to 6, 3 to 6 or 3 to 5. The form of the fused ring is not particularly limited, and may be a linear fused ring type and/or a wing-like fused ring type, which is particularly applicable to the cyclic organic compound having a two-dimensional structure.

Although it is merely an example, examples of the fused ring compounds in the present application include at least one selected from the group consisting of pentalene, inden, naphthalene, azulene, heptalene, biphenylene, as-indacene, s-indacene, acenaphthylene, fluorene, phenalene, phenanthrene, anthracene, fluolanthene, acephenanthrylene, aceanthrylene, triphenylene, pyrene, chrysene, tetracene, pleiadene, picene, perylene, pentaphene, pentacene, tetraphenylene, hexaphene, and derivatives thereof.

The aromatic fused ring compound may be a cyclic organic compound having a plurality of rings that can be formed by supplying at least one ring side thereof to each other by monocyclic rings of the aforementioned number, that is, a plurality of fused rings. Such aromatic fused rings may be connected to each other in the form of linear fused rings, or may be connected to each other in the form of wing-like fused rings.

On the other hand, the cyclic organic compound having a three-dimensional structure has a molecular structure in which individual monocyclic rings share two or more sides to form a three-dimensional structure. In a preferred aspect, the cyclic organic compound has a three-dimensionally closed molecular structure in which all sides of monocyclic rings are shared by the rings. Such a cyclic organic compound is preferably fullerene or a derivative thereof. Fullerene C60 (Chemical Formula 28) is three-dimensionally formed of, for example, 12 five-membered rings and 20 six-membered rings connected to each other. That is, in the fullerene, the rings are connected to each other so as to form a three-dimensional shape as described above, and preferably, the fullerene has a spherical shape as a whole. That is, as illustrated by fullerene and the like, the cyclic organic compound has a non-planar molecular structure (preferably a spherical molecular structure) as a whole. The fullerene is not limited to C60, but may be C70, or may be a higher-order fullerene (C84, C90, C96, and the like) having a higher molecular weight.

In a preferred aspect, the fused ring compound is a benzene-based condensed compound. That is, the fused ring compound may have a ring structure in which two or more benzene rings are fused while using the benzene ring as a base. For example, there may be two benzene rings. For example, there are three benzene rings, and therefore, the fused ring compound may be phenanthrene, anthracene or a derivative thereof. Alternatively, there are five benzene rings, and therefore, the fused ring compound may be picene, pentaphene, pentacene or a derivative thereof.

As a more specific preferred example when there are three benzene rings, the fused ring compound contained in the electrolytic solution application may have an anthracene skeleton. That is, the fused ring compound may be a fused ring compound having, as a main skeleton, a ring structure in which three benzene rings are fused.

In the present specification, the derivative means that a predetermined compound may have a substituent. The substituent is, for example, one or more groups selected from the group consisting of a hydrocarbon group, a halogen atom, an oxygen-containing functional group, a nitrogen-containing functional group, and a sulfur-containing functional group.

The hydrocarbon groups may be each independently aliphatic hydrocarbon group, aromatic hydrocarbon group or aromatic aliphatic hydrocarbon group. The aliphatic hydrocarbon group, the aromatic hydrocarbon group and the aromatic-aliphatic hydrocarbon group do not necessarily have to have a linear structure, and may have a branched structure. The aliphatic hydrocarbon group may be a saturated hydrocarbon or an unsaturated hydrocarbon. The carbon number of each of such hydrocarbon groups may be about 1 to 50 (for example, 1 to 40, 1 to 30, 1 to 20 or 1 to 10).

The oxygen-containing functional group is a functional group containing at least an oxygen atom, and examples thereof include a hydroxy group, a carboxy group, an epoxy group and/or an aldehyde group. Furthermore, the oxygen-containing functional group may correspond to an ether bond site or an ester bond site.

The nitrogen-containing functional group is a functional group containing at least a nitrogen atom, and examples thereof include an amino group, a nitro group and/or a nitroso group.

The sulfur-containing group is a functional group containing at least a sulfur atom, and examples thereof include a thiol group, a sulfide group, a disulfide group, a sulfonyl group, a sulfo group, a thiocarbonyl group and/or a thiourea group.

The oxygen-containing functional group, the nitrogen-containing functional group and the sulfur-containing group in the present specification may each have both concepts, and further may be in a category of a hydrocarbon group (aliphatic hydrocarbon group, aromatic hydrocarbon group or aromatic-aliphatic hydrocarbon group).

The “cyclic organic compound having a two-dimensional structure or a three-dimensional structure” is preferably a cyclic organic compound having a two-dimensional structure, and more preferably anthracene or a derivative thereof, from the viewpoint of further improving the discharging capacity.

The content of the “cyclic organic compound having a two-dimensional structure or a three-dimensional structure” may be, for example, 1 M or less (particularly, more than 0 M and 1 M or less) (based on the entire electrolytic solution), and from the viewpoint of further improving the discharging capacity, may be preferably 0.001 M or more and 1 M or less (based on the entire electrolytic solution), and more preferably 0.005 M or more and 0.1 M or less (based on the entire electrolytic solution). When the electrolytic solution contains two or more kinds of “cyclic organic compound having a two-dimensional structure or a three-dimensional structure”, the total content thereof may be within the above range.

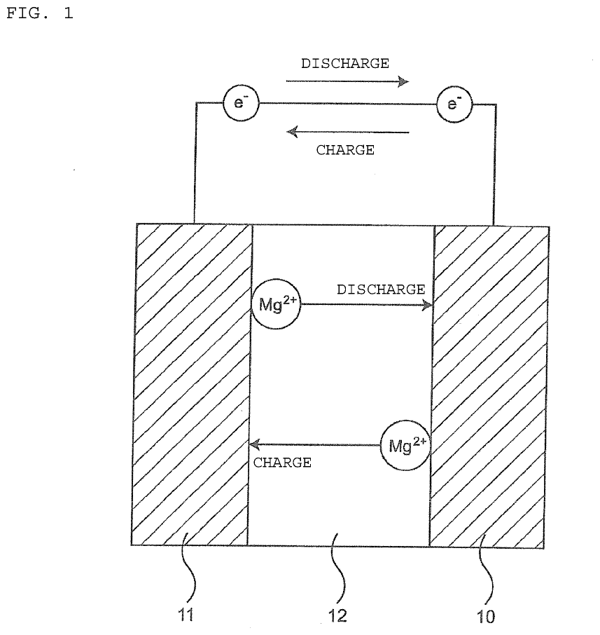

The electrochemical device of the present application can be configured as a secondary battery, and a conceptual diagram in that case is illustrated in FIG. 1. As illustrated in the drawing, during charging, magnesium ions (Mg²⁺) move from a positive electrode 10 to a negative electrode 11 through an electrolyte layer 12 to convert electrical energy into chemical energy and store electricity. During discharging, magnesium ions return from the negative electrode 11 to the positive electrode 10 through the electrolyte layer 12 to generate electric energy.

When the electrochemical device is a battery (primary battery or secondary battery) formed of the positive electrode of the present application, such a battery can be used as a driving power source or an auxiliary power source of, for example, a notebook type personal computer, a personal digital assistant (PDA), a mobile phone, a smart phone, a master unit and a slave unit of cordless phone, a video movie, a digital still camera, an electronic book, an electronic dictionary, a portable music player, a radio, a headphone, a game machine, a navigation system, a memory card, a cardiac pacemaker, a hearing aid, an electric tool, an electric shaver, a refrigerator, an air conditioner, a television receiver, a stereo, a water heater, a microwave oven, a dishwasher, a washing machine, a dryer, a lighting apparatus, a toy, a medical device, a robot, a road conditioner, a traffic light, a railway vehicle, a golf cart, an electric cart, and/or an electric car (including a hybrid car). In addition, the battery can be mounted on a building such as a house, a power source for power storage that is used for power generation facilities, or the like, or can be used in order to supply electric power thereto. In an electric car, a conversion device that converts electric power into a driving force by supplying electric power is generally a motor. Examples of the control device (control unit) that processes information related to vehicle control includes a control device that displays the remaining battery level based on information on the remaining battery level. The battery can also be used in an electric storage device in a so-called smart grid. Such a power storage device can not only supply electric power but also store electric power by receiving electric power supply from other power source. As the “other power source”, for example, thermal power generation, nuclear power generation, hydroelectric power generation, a solar battery, wind power generation, geothermal power generation, and/or a fuel cell (including a biofuel cell), or the like can be used.

The electrochemical device (that is, secondary battery) of the present application can be applied to a secondary battery, a control unit (or control unit) for controlling a secondary battery, and a battery pack having an exterior enclosing the secondary battery. In the battery pack, the control means can control, for example, charging and discharging, overdischarge or overcharge of the secondary battery.

The electrochemical device (namely, the secondary battery) of the present application can also be applied to an electronic apparatus that receives supply of electric power from a secondary battery.

The electrochemical device of the present application can also be applied to a secondary battery in an electric vehicle including a conversion device for converting electric power supplied from the secondary battery into a driving force of the vehicle and a control device (or control unit) for performing information processing related to vehicle control based on information on the secondary battery. In this electric vehicle, the conversion device typically receives electric power from the secondary battery, drives a motor, and generates a driving force. The motor can be driven also by utilizing regenerative energy. The control device (or a control unit) performs information processing related to vehicle control based on, for example, the remaining battery level of the secondary battery. Examples of such an electrically driven vehicle include an electric car, an electric motorcycle, an electric bicycle, and a railway vehicle, and also a so-called hybrid vehicle.

The electrochemical device (that is, secondary battery) of the present application can be applied to a power system configured to receive the supply of an electric power from a secondary battery and/or supply the electric power from a power source to the secondary battery. The power system as described above may be any power system as long as the system uses electric power, and includes a simple electric power device. Such power systems include, for example, smart grids, household energy management systems (HEMS), and/or vehicles, or the like, and can also store electricity.

The electrochemical device (that is, secondary battery) of the present application can be applied to a power storage power source configured to have a secondary battery and be connected to an electronic device to which electric power is supplied. This power source for power storage can be basically used for any power system or power device regardless of the application of the power source for power storage, and can be used for a smart grid, for example.

Other details such as more detailed matters and further specific aspects of the electrochemical device of the present application are described above, and therefore the description thereof is omitted to avoid duplication.

Here, the case where the magnesium electrode-based electrochemical device of the present application is used as a secondary battery will be described in more detail. Hereinafter, such a secondary battery is also referred to as a “magnesium secondary battery”.

The magnesium secondary battery as the electrochemical device of the present application can be applied to machines, apparatuses, appliances, devices, and systems (assemblies of a plurality of apparatuses and the like) which can utilize the magnesium secondary battery as a driving/operating power source or an electric power storage source for electric power accumulation without particular limitation. The magnesium secondary battery (for example, a magnesium-sulfur secondary battery) used as a power source may be a main power source (a power source used preferentially) or an auxiliary power source (a power source used in place of or switched from the main power source). When a magnesium secondary battery is used as an auxiliary power source, the main power source is not limited to a magnesium secondary battery.

Specific examples of an application of the magnesium secondary battery (particularly, magnesium-sulfur secondary battery) include various electronic devices and electric devices (including portable electronic devices) such as a video camera, a camcorder, a digital still camera, a mobile phone, a personal computer, a television receiver, various display devices, a cordless phone, a headphone stereo, a music player, a portable radio, electronic paper such as an electronic book and/or an electronic newspaper, or a portable information terminal including PDA; a toy; a portable living appliance such as an electric shaver; a lighting appliance such as an interior light; a medical electronic device such as a pacemaker and/or a hearing aid; a storage device such as a memory card; a battery pack used as a detachable power source for a personal computer or the like; an electric tool such as an electric drill and/or an electric saw; a power storage system and/or a home energy server (household power storage device) such as a household battery system for accumulating electric power in preparation for emergency or the like and a power supply system; a power storage unit and/or a backup power source; an electric vehicle such as an electric car, an electric motorcycle, an electric bicycle, and/or Segway (registered trademark); and a power driving force conversion device of an airplane and/or a ship (specifically, for example, a power motor), but are not limited to these applications.

Above all, the magnesium secondary battery (particularly, the magnesium-sulfur secondary battery) is effectively applied to, for example, a battery pack, an electric vehicle, a power storage system, a power supply system, an electric tool, an electronic device, and/or an electric device. The battery pack is a power source using a magnesium secondary battery, and is a so-called assembled battery or the like. The electrically driven vehicle is a vehicle that operates (for example, travels) using a magnesium secondary battery as a driving power source, and may be an automobile also including a driving source other than the secondary battery (for example, a hybrid car). The power storage system (for example, a power supply system) is a system using a magnesium secondary battery as a power storage source. For example, in a home power storage system (power supply system), electric power is stored in a magnesium secondary battery as a power storage source, and thus home electric appliances and the like can be used using electric power. The electric tool is a tool in which a movable portion (for example, a drill) moves using the magnesium secondary battery as a driving power source. The electronic device and the electric device are devices that exhibit various functions using a magnesium secondary battery as a power source (that is, power supply source) for operation.

Hereinafter, a cylindrical magnesium secondary battery and a flat laminate film type magnesium secondary battery will be described.

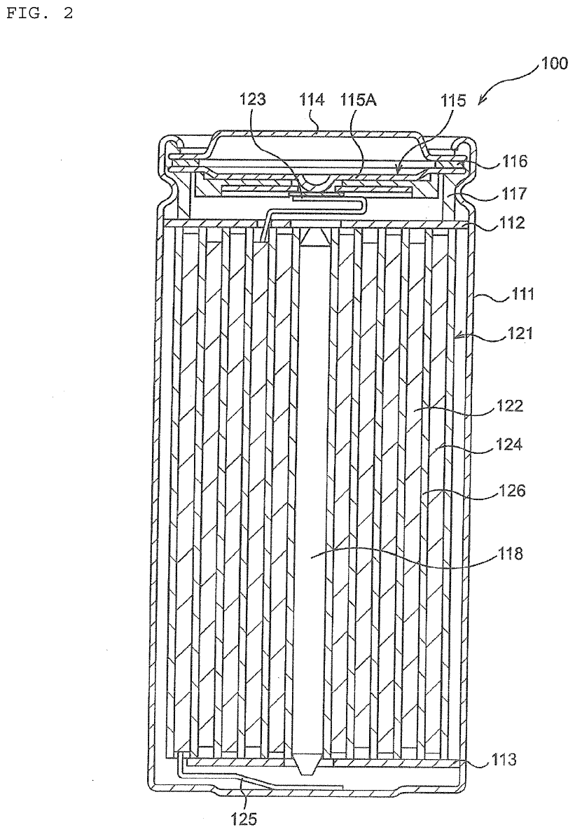

FIG. 2 illustrates a schematic sectional view of a cylindrical magnesium secondary battery 100. In the magnesium secondary battery 100, an electrode structure 121 and a pair of insulating plates 112 and 113 are housed in a substantially hollow cylindrical electrode structure housing member 111. The electrode structure 121 can be produced, for example, by stacking a positive electrode 122 and a negative electrode 124 with a separator 126 interposed therebetween to obtain an electrode structure and then winding the electrode structure. The electrode structure housing member (for example, a battery can) 111 has a hollow structure in which one end portion is closed and the other end is open, and includes iron (Fe) and/or aluminum (Al). The pair of insulating plates 112 and 113 is disposed so as to sandwich the electrode structure 121 and extend perpendicularly to the winding peripheral surface of the electrode structure 121. A battery lid 114, a safety valve mechanism 115, and a positive temperature coefficient element (for example, PTC element) 116 are crimped to the open end portion of the electrode structure housing member 111 with a gasket 117 interposed therebetween, and the electrode structure housing member 111 is thereby sealed. The battery lid 114 includes, for example, the same material as that of the electrode structure housing member 111. The safety valve mechanism 115 and the positive temperature coefficient element 116 are provided inside the battery lid 114, and the safety valve mechanism 115 is electrically connected to the battery lid 114 with the positive temperature coefficient element 116 interposed therebetween. In the safety valve mechanism 115, a disk plate 115A is reversed when the internal pressure becomes equal to or higher than a certain level due to internal short circuit and/or external heating. As a result, the electrical connection between the battery lid 114 and the electrode structure 121 is disconnected. For preventing abnormal heat generation due to a large amount of current, the resistance of the positive temperature coefficient element 116 increases as the temperature rises. The gasket 117 is prepared from, for example, an insulating material. The surface of the gasket 117 may be coated with asphalt or the like.

A center pin 118 is inserted into the winding center of the electrode structure 121. However, the center pin 118 may not be inserted into the winding center. A positive electrode lead portion 123 produced using a conductive material such as aluminum is connected to the positive electrode 122. Specifically, the positive electrode lead portion 123 is attached to a positive electrode current collector. A negative electrode lead portion 125 produced using a conductive material such as copper is connected to the negative electrode 124. Specifically, the negative electrode lead portion 125 is attached to a negative electrode current collector. The negative electrode lead portion 125 is welded to the electrode structure housing member 111 and is electrically connected to the electrode structure housing member 111. The positive electrode lead portion 123 is welded to the safety valve mechanism 115 and is electrically connected to the battery lid 114. In the example illustrated in FIG. 2, the negative electrode lead portion 125 is disposed at one place (the outermost peripheral portion of the wound electrode structure), but may be disposed at two places (the outermost peripheral portion and the innermost peripheral portion of the wound electrode structure).

The electrode structure 121 includes the positive electrode 122 having a positive electrode active material layer formed on the positive electrode current collector (more specifically, on both surfaces of the positive electrode current collector) and the negative electrode 124 having a negative electrode active material layer formed on the negative electrode current collector (more specifically, on both surfaces of the negative electrode current collector) stacked with the separator 126 interposed therebetween. The positive electrode active material layer is not formed in a region of the positive electrode current collector to which the positive electrode lead portion 123 is attached, and the negative electrode active material layer is not formed in a region of the negative electrode current collector to which the negative electrode lead portion 125 is attached.

The magnesium secondary battery 100 can be produced, for example, based on the following procedure.

First, positive electrode active material layers are formed on both surfaces of the positive electrode current collector, and negative electrode active material layers are formed on both surfaces of the negative electrode current collector.

Subsequently, the positive electrode lead portion 123 is attached to the positive electrode current collector by a welding method or the like. The negative electrode lead portion 125 is attached to the negative electrode current collector by a welding method or the like. Subsequently, the positive electrode 122 and the negative electrode 124 are stacked with the separator 126 including a microporous polyethylene film interposed therebetween, and are wound (more specifically, the electrode structure (that is, stacked structure) of the positive electrode 122/the separator 126/the negative electrode 124/the separator 126 is wound) to produce the electrode structure 121, and then, a protective tape (not illustrated) is attached to an outermost peripheral portion. Thereafter, the center pin 118 is inserted into a center of the electrode structure 121. Then, the electrode structure 121 is housed inside the electrode structure housing member 111 while the electrode structure 121 is sandwiched between the pair of insulating plates 112 and 113. In this case, a tip end portion of the positive electrode lead portion 123 is attached to the safety valve mechanism 115, and a tip end portion of the negative electrode lead portion 125 is attached to the electrode structure housing member 111 with the use of a welding method or the like. Thereafter, an electrolytic solution is injected based on a decompression method, and the separator 126 is impregnated with the electrolytic solution. Subsequently, the battery lid 114, the safety valve mechanism 115, and the positive temperature coefficient element 116 are crimped to an opening end portion of the electrode structure housing member 111 with the gasket 117 interposed therebetween.

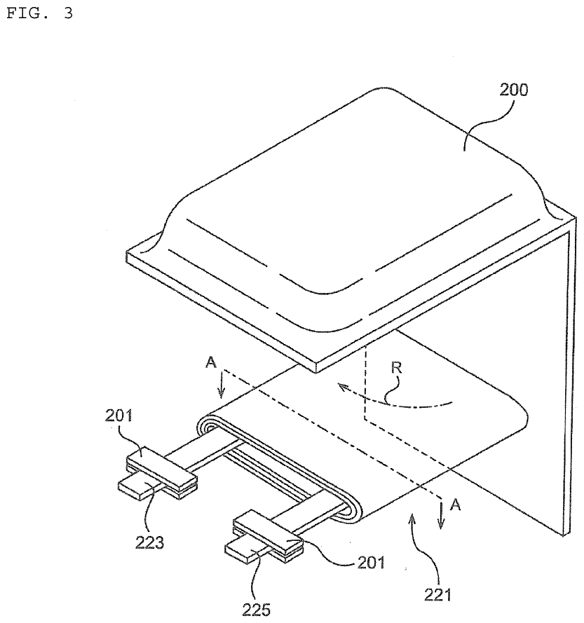

Next, a flat laminate film type magnesium secondary battery will be described. FIG. 3 illustrates a schematic exploded perspective view of such a secondary battery. In this secondary battery, an electrode structure 221 basically similar to that described above is housed inside an exterior member 200 including a laminated film. The electrode structure 221 can be manufactured by stacking a positive electrode and a negative electrode with a separator and an electrolyte layer interposed therebetween, and then winding this stacked structure. A positive electrode lead portion 223 is attached to the positive electrode, and a negative electrode lead portion 225 is attached to the negative electrode. The outermost peripheral portion of the electrode structure 221 is protected by a protective tape. The positive electrode lead portion 223 and the negative electrode lead portion 225 protrude in the same direction from the inside to the outside of the exterior member 200. The positive electrode lead portion 223 includes a conductive material such as aluminum. The negative electrode lead portion 225 includes a conductive material such as copper, nickel, and/or stainless steel.

The exterior member 200 is a single film foldable in the direction of the arrow R illustrated in FIG. 3, and a recess (for example, emboss) for housing the electrode structure 221 is provided in a part of the exterior member 200. The exterior member 200 is, for example, a laminate film in which a fusion layer, a metal layer, and a surface protective layer are stacked in this order. In a step of producing the secondary battery, the exterior member 200 is folded such that the fusion layers face each other with the electrode structure 221 interposed therebetween, and then the outer peripheral edges of the fusion layers are fused to each other. However, the exterior member 200 may be formed by bonding two separate laminate films to each other with an adhesive or the like interposed therebetween. The fusion layer includes, for example, a film of polyethylene and/or polypropylene. The metal layer includes, for example, an aluminum foil or the like. The surface protective layer includes, for example, nylon and/or polyethylene terephthalate. In particular, the exterior member 200 may be an aluminum laminate film that has a polyethylene film, an aluminum foil, and a nylon film laminated in this order. However, the exterior member 200 may be a laminate film that has another laminated structure, a polymer film such as a polypropylene, or a metal film. Specifically, the exterior member 200 may include a moisture-resistant aluminum laminate film that has a nylon film, an aluminum foil, and an unstretched polypropylene film laminated in this order from the outside.

In order to prevent entry of outside air, a close contact film 201 is inserted between the exterior member 200 and the positive electrode lead portion 223 and between the exterior member 200 and the negative electrode lead portion 225. The close contact film 201 may include a material having a close contact property to the positive electrode lead portion 223 and the negative electrode lead portion 225, for example, a polyolefin resin, and more specifically, may include a polyolefin resin such as polyethylene, polypropylene, modified polyethylene, or modified polypropylene.

Although the above description has focused primarily on secondary batteries, the present disclosure also applies to other electrochemical devices such as capacitors, air batteries, and fuel cells. This will be described below.

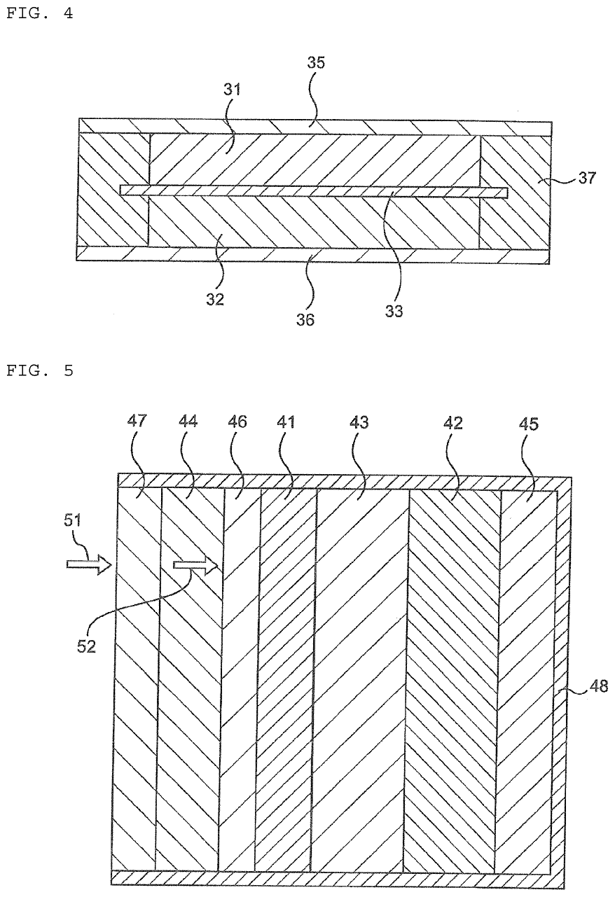

The electrochemical device of the present application can be provided as a capacitor of which a schematic sectional view is illustrated in FIG. 4. In the capacitor, a positive electrode 31 and a negative electrode 32 are disposed to face each other with a separator 33 impregnated with the electrolytic solution interposed therebetween. A gel electrolyte membrane impregnated with an electrolytic solution may be disposed on the surface of at least one of the separator 33, the positive electrode 31, or the negative electrode 32. Reference numerals 35 and 36 denote current collectors, and reference numeral 37 denotes a gasket.

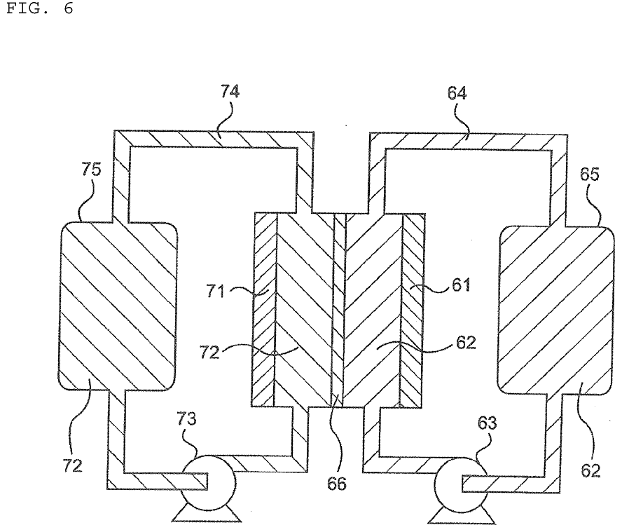

Alternatively, the electrochemical device of the present application can also be provided as an air battery as illustrated in the conceptual diagram of FIG. 5. Such an air battery is constituted of, for example, an oxygen-selective permeable membrane 47 through which water vapor hardly permeates and oxygen can permeate selectively, an air electrode-side current collector 44 including a conductive porous material, a porous diffusion layer 46 disposed between the air electrode-side current collector 44 and a porous positive electrode 41 and including a conductive material, the porous positive electrode 41 including a conductive material and a catalyst material, a separator through which water vapor hardly permeates and an electrolytic solution (or a solid-state electrolyte containing an electrolytic solution) 43, a negative electrode 42 which releases magnesium ions, a negative electrode-side current collector 45, and an exterior body 48 in which these layers are housed.

Oxygen 52 in air (for example, atmosphere) 51 is selectively allowed to permeate the oxygen-selective permeable membrane 47, passes through the air electrode-side current collector 44 formed using the porous material, is diffused by the diffusion layer 46, and is supplied to the porous positive electrode 41. The travel of the oxygen that has permeated through the oxygen-selective permeable membrane 47 is blocked in part by the air electrode-side current collector 44, but since the oxygen that has passed through the air electrode-side current collector 44 is diffused and spread by the diffusion layer 46, the oxygen efficiently spreads over the entire porous positive electrode 41, and the supply of oxygen to the entire surface of the porous positive electrode 41 is not inhibited by the air electrode-side current collector 44. In addition, since the permeation of water vapor is controlled by the oxygen-selective permeable membrane 47, deterioration due to the influence of moisture in the air is small, and oxygen is efficiently supplied to the entire porous positive electrode 41, so that the battery output can be increased and the battery can be stably used for a long period.

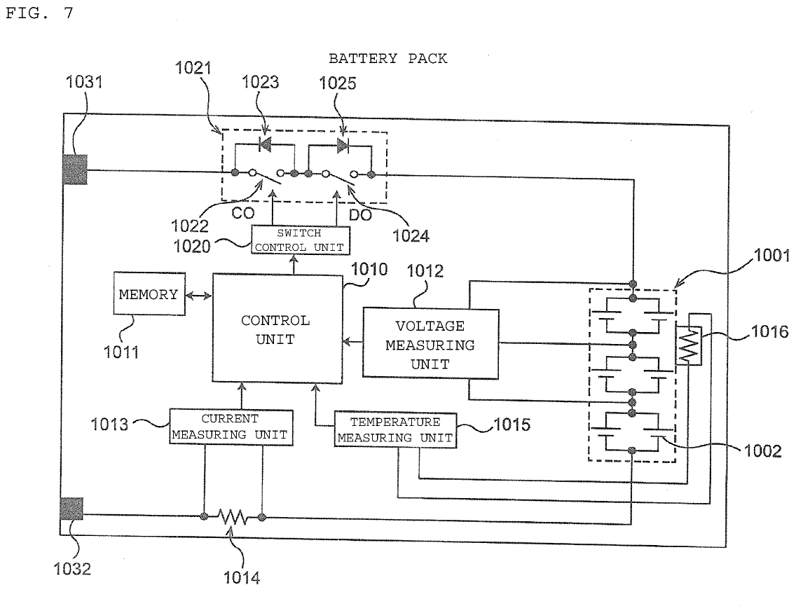

Alternatively, the electrochemical device of the present application can also be provided as a fuel cell as illustrated in the conceptual diagram of FIG. 6. The fuel cell includes, for example, a positive electrode 61, a positive electrode electrolytic solution 62, a positive electrode electrolytic solution transport pump 63, a fuel flow path 64, a positive electrode electrolytic solution storage container 65, a negative electrode 71, a negative electrode electrolytic solution 72, a negative electrode electrolytic solution transport pump 73, a fuel flow path 74, a negative electrode electrolytic solution storage container 75, and an ion-exchange membrane 66. In the fuel flow path 64, the positive electrode electrolytic solution 62 continuously or intermittently flows (circulates) through the positive electrode electrolytic solution storage container 65 and the positive electrode electrolytic solution transport pump 63. In the fuel flow path 74, the negative electrode electrolytic solution 72 continuously or intermittently flows (circulates) through the negative electrode electrolytic solution storage container 75 and the negative electrode electrolytic solution transport pump 73. Power is generated between the positive electrode 61 and the negative electrode 71. A material obtained by adding a positive electrode active material to the electrolytic solution may be used as the positive electrode electrolytic solution 62. A material obtained by adding a negative electrode active material to the electrolytic solution may be used as the negative electrode electrolytic solution 72.

As for the negative electrode in the electrochemical device, a Mg metal plate can be used, and the negative electrode can also be produced by the following method. For example, a Mg plating layer may be formed on a Cu foil as a negative electrode active material layer by preparing a Mg electrolytic solution (Mg-EnPS) containing MgCl₂ and EnPS (ethyl-n-propylsulfone), and depositing Mg metal on a Cu foil based on an electrolytic plating method using the Mg electrolytic solution. Incidentally, as a result of the analysis based on the XPS method of a surface of the Mg plating layer obtained by such a method, it was clarified that Mg, C, O, S and Cl were present on the surface of the Mg plating layer, a Mg-derived peak observed by surface analysis was not split, and a single peak derived from Mg was observed in the range of 40 eV or more and 60 eV or less. Furthermore, the surface of the Mg plating layer was dug by about 200 nm in the depth direction on the basis of the Ar sputtering method, and the surface was analyzed on the basis of the XPS method. As a result, it was found that the position and shape of the Mg-derived peak after the Ar sputtering did not change as compared with the position and shape of the peak before the Ar sputtering.

Although the electrochemical device according to the present application can be particularly used as a magnesium secondary battery as described with reference to FIGS. 1 to 3, several application examples of such a magnesium secondary battery will be more specifically described. It is noted that the configuration of each application example described below is merely an example and the configuration can be appropriately changed.

The magnesium secondary battery can be used in the form of a battery pack. Such a battery pack is a simple battery pack (so-called soft pack) using a magnesium secondary battery, and is mounted on, for example, an electronic device typified by a smartphone. Alternatively or additionally, the battery pack may include an assembled battery including six magnesium secondary batteries connected in 2 parallel and 3 series. The connection type of the magnesium secondary batteries may be in series, in parallel, or a combination of both.

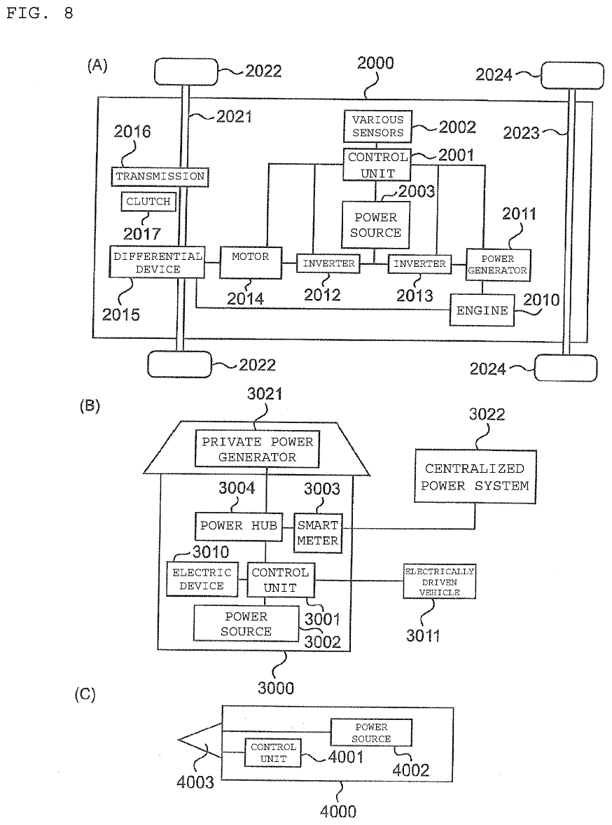

FIG. 7 illustrates a block diagram showing a circuit configuration example in a case where the magnesium secondary battery of the present application is applied to a battery pack. The battery pack includes a cell (for example, assembled battery) 1001, an exterior member, a switch unit 1021, a current detection resistor 1014, a temperature detection element 1016, and a control unit 1010. The switch unit 1021 includes a charge control switch 1022 and a discharge control switch 1024. The battery pack includes a positive electrode terminal 1031 and a negative electrode terminal 1032, and during charge, the positive electrode terminal 1031 and the negative electrode terminal 1032 are connected to a positive electrode terminal and a negative electrode terminal of a charger, respectively and the charge is carried out. When an electronic device is used, the positive electrode terminal 1031 and the negative electrode terminal 1032 are connected to a positive electrode terminal and a negative electrode terminal of the electronic device, respectively and discharge is carried out.

The cell 1001 is configured by connecting a plurality of magnesium secondary batteries 1002 in the present disclosure in series and/or in parallel. Although FIG. 7 illustrates a case where six magnesium secondary batteries 1002 are connected in 2 parallel and 3 series (2P3S), the connection method may be any the connection method such as p parallel and q series (where p and q are integers).

The switch unit 1021 includes a charge control switch 1022 and a diode 1023 as well as a discharge control switch 1024 and a diode 1025, and is controlled by the control unit 1010. The diode 1023 has a backward polarity with respect to a charge current flowing in a direction from the positive electrode terminal 1031 toward the cell 1001, and a forward polarity with respect to a discharge current flowing in a direction from the negative electrode terminal 1032 toward the cell 1001. The diode 1025 has a forward polarity with respect to the charge current and a backward polarity with respect to the discharge current. In the example, the switch unit is provided on the plus (+) side, but may be provided on the minus (−) side. The control unit 1010 controls the charge control switch 1022 such that the charge control switch 1022 is closed when the battery voltage has reached the overcharge detection voltage, and no charge current flows in the current path of the cell 1001. After the charge control switch 1022 is closed, only discharge can be performed through the diode 1023. The control unit 1010 controls the charge control switch 1022 such that the charge control switch 1022 is closed in a case where a large amount of current flows during charging, and a charge current flowing in a current path of the cell 1001 is cut off. The control unit 1010 controls the discharge control switch 1024 such that the discharge control switch 1024 is closed when the battery voltage has reached the overdischarge detection voltage, and no discharge current flows in the current path of the cell 1001. After the discharge control switch 1024 is closed, only charge can be performed through the diode 1025. The discharge control switch 1024 is put into a closed state when a large current flows during discharging, and is controlled by the control unit 1010 so as to cut off the discharge current flowing in the current path of the cell 1001.

The temperature detection element 1016 includes, for example, a thermistor and is provided in the vicinity of the cell 1001, and a temperature measuring unit 1015 measures the temperature of the cell 1001 using the temperature detection element 1016 and sends the measurement result to the control unit 1010. A voltage measuring unit 1012 measures the voltage of the cell 1001 and the voltage of each of the magnesium secondary batteries 1002 constituting the cell 1001, A/D converts the measurement results, and sends the converted result to the control unit 1010. A current measuring unit 1013 measures the current using the current detection resistor 1014, and sends the measurement result to the control unit 1010.

A switch control unit 1020 controls the charge control switch 1022 and the discharge control switch 1024 of the switch unit 1021 on the basis of a voltage and a current sent from the voltage measuring unit 1012 and the current measuring unit 1013. When a voltage of any one of the magnesium secondary batteries 1002 becomes equal to or lower than the overcharge detection voltage or overdischarge detection voltage and/or when a large amount of current rapidly flows, the switch control unit 1020 sends a control signal to the switch unit 1021 and prevents overcharging, overdischarging, and overcurrent charging and discharging. The charge control switch 1022 and the discharge control switch 1024 each can be constituted of, for example, a semiconductor switch such as MOSFET. In this case, the diodes 1023 and 1025 are each constituted of a parasitic diode of MOSFET. In a case where a p-channel FET is used as a MOSFET, the switch control unit 1020 supplies a control signal DO and a control signal CO to the gates of the charge control switch 1022 and the discharge control switch 1024, respectively. The charge control switch 1022 and the discharge control switch 1024 become conductive due to a gate potential lower than the source potential by a predetermined value or more. That is, in normal charging and discharging operations, the control signals CO and DO are set at low levels, and the charge control switch 1022 and the discharge control switch 1024 are kept conductive. In addition, for example, at the time of overcharge or overdischarge, the control signals CO and DO are set at high levels, and the charge control switch 1022 and the discharge control switch 1024 are closed.

A memory 1011 includes, for example, an erasable programmable read only memory (EPROM), which is a nonvolatile memory. The memory 1011 stores in advance a numerical value calculated by the control unit 1010 and/or an internal resistance value and the like of each of the magnesium secondary batteries 1002 in the initial state measured at the stage of the producing process, and these values can be rewritten as appropriate. In addition, by storing the full charge capacitance of the magnesium secondary battery 1002, the memory 1011 can calculate, for example, a remaining capacity together with the control unit 1010.

The temperature measuring unit 1015 measures the temperature using the temperature detection element 1016, performs charging and discharging control when abnormal heat generation occurs, and corrects the calculation of the remaining capacity.

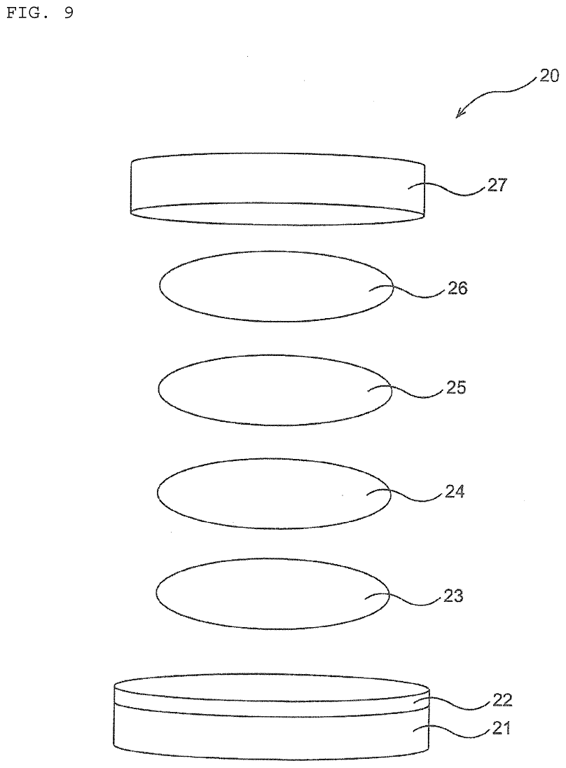

Next, the application of the magnesium secondary battery to an electric vehicle will be described. FIG. 8A illustrates a block diagram illustrating a configuration of an electrically driven vehicle such as a hybrid car, which is one example of the electrically driven vehicle. The electrically driven vehicle includes, for example, a control unit 2001, various sensors 2002, a power source 2003, an engine 2010, a power generator 2011, inverters 2012 and 2013, a driving motor 2014, a differential device 2015, a transmission 2016, and a clutch 2017 in a metal housing 2000. In addition, the electrically driven vehicle includes, for example, a front wheel drive shaft 2021, front wheels 2022, a rear wheel drive shaft 2023, and rear wheels 2024 connected to the differential device 2015 and/or the transmission 2016.

The electric vehicle can travel, for example, using either the engine 2010 or the motor 2014 as a drive source. The engine 2010 is a main power source and is, for example, a gasoline engine. In a case where the engine 2010 is used as a power source, a driving force (for example, rotational force) of the engine 2010 is transmitted to, for example, the front wheels 2022 or the rear wheels 2024 through, for example, the differential device 2015, the transmission 2016, and the clutch 2017, which are drive units. The rotational force of the engine 2010 is also transmitted to the power generator 2011, the power generator 2011 generates AC power using the rotational force, the AC power is converted into DC power via the inverter 2013, and the DC power is accumulated in the power source 2003. On the other hand, in the case in which the motor 2014, which is a conversion unit, is used as the power source, the electric power (for example, DC power) supplied from the power source 2003 is converted into AC power via the inverter 2012, and the motor 2014 is driven using the AC power. The driving force (for example, rotational force) converted from the electric power by the motor 2014 is transmitted to the front wheels 2022 or the rear wheels 2024, for example, through the differential device 2015, the transmission 2016, and the clutch 2017, which are drive units.

It is also permissible that when the electric vehicle is decelerated via a braking mechanism (not shown), the resistance force generated during the deceleration is transmitted to the motor 2014 as a rotational force, and the motor 2014 generates AC power utilizing the rotational force. The alternating current power is converted into direct current power via the inverter 2012, and the direct current regenerative electric power is accumulated in the power source 2003.

The control unit 2001 is a unit that controls the operation of the entire electrically driven vehicle, and includes, for example, a CPU and the like. The power source 2003 can include one or two or more magnesium secondary batteries (not shown) according to the present application. The power source 2003 also may be configured to be connected to an external power supply and accumulate electric power by receiving power supply from the external power source. The various sensors 2002 are used, for example, to control the rotation speed of the engine 2010 and to control the opening degree (throttle opening degree) of a throttle valve (not illustrated). The various sensors 2002 include, for example, a speed sensor, an acceleration sensor, and/or an engine rpm sensor, and the like.

Although the case where the electric vehicle is a hybrid car has been described, the electric vehicle may be a vehicle that operates only using the power source 2003 and the motor 2014 without using the engine 2010 (for example, an electric car).

Next, application of the magnesium secondary battery to a power storage system (for example, power supply system) will be described. FIG. 8B illustrates a block diagram showing a configuration of a power storage system (for example, power supply system). The power storage system includes, for example, a control unit 3001, a power source 3002, a smart meter 3003, and a power hub 3004 inside a house 3000 such as a general house or a commercial building.

The power source 3002 can be connected to, for example, an electric device (for example, an electronic device) 3010 installed inside the house 3000 and an electrically driven vehicle 3011 stopped outside the house 3000. Furthermore, for example, the power source 3002 is connected to a private power generator 3021 installed in the house 3000 with a power hub 3004 interposed therebetween, and can be connected to an external centralized power system 3022 via the smart meter 3003 and the power hub 3004. The electric device (for example, electronic device) 3010 includes, for example, one or more home electric appliances. Examples of the home electric appliance include a refrigerator, an air conditioner, a television receiver, and/or a water heater. The private power generator 3021 includes, for example, a solar power generator and/or a wind power generator. Examples of the electrically driven vehicle 3011 include an electric car, a hybrid car, an electric motorcycle, an electric bicycle, and/or Segway (registered trademark). Examples of the centralized power system 3022 include a commercial power source, a power generation device, a power transmission network, and/or a smart grid (for example, next generation power transmission network). Furthermore, examples thereof include a thermal power plant, a nuclear power plant, a hydraulic power plant, and/or a wind power plant. Examples of the power generation device included in the centralized power system 3022 include various solar batteries, a fuel battery, a wind power generation device, a micro hydraulic power generation device, and/or a geothermal power generation device. However, the centralized power system 3022 and the power generation device are not limited thereto.

The control unit 3001 controls the operation of the whole electric power storage system (including a usage state of the power source 3002), and includes, for example, a CPU and the like. The power source 3002 can include one or two or more magnesium secondary batteries (not shown) according to the present application. The smart meter 3003 is, for example, a network-compatible power meter to be installed in the house 3000 on the power demand side, and can communicate with the power supply side. The smart meter 3003 can efficiently and stably supply energy, for example, by controlling the balance between demand and supply in the house 3000 while communicating with outside.

In such a power storage system, for example, electric power is accumulated in the power source 3002 from the centralized power system 3022 as an external power source via the smart meter 3003 and the power hub 3004, and electric power is accumulated in the power source 3002 from the private power generator 3021 as an independent power source via the power hub 3004. The electric power accumulated in the power source 3002 is supplied to the electric device (for example, electronic device) 3010 and the electrically driven vehicle 3011 according to an instruction of the control unit 3001, so that the electric device (for example, electronic device) 3010 can operate and the electrically driven vehicle 3011 can be charged. That is, the power storage system is a system which makes it possible to accumulate and supply electric power in the house 3000 using the power source 3002.

The electric power accumulated in the power source 3002 can be optionally used. Therefore, for example, it is possible to accumulate electric power from the centralized power system 3022 to the power source 3002 during the midnight when the electricity charge is low and use the electric power accumulated in the power source 3002 during the daytime when the electricity charge is high.

The power storage system described above may be installed in each house (for example, each household) or may be installed in every plurality of houses (for example, every plurality of households).

Next, application of the magnesium secondary battery to an electric tool will be described. FIG. 8C illustrates a block diagram showing a configuration of the electric tool. The electric tool is, for example, an electric drill, and includes a control unit 4001 and a power source 4002 inside a tool body 4000 including a plastic material or the like. For example, a drill unit 4003, which is a movable portion, is rotatably attached to the tool body 4000. The control unit 4001 is a unit that controls the operation of the entire electric tool (including a used state of the power source 4002), and includes a CPU, for example. The power source 4002 can include one or two or more magnesium secondary batteries (not shown) according to the present application. The control unit 4001 supplies electric power from the power source 4002 to the drill unit 4003 in response to the operation of an operation switch (not illustrated).

Although one or more embodiments of the present application have been described above, the present application is not limited thereto, and thus, the subject matter of the present application can be modified in a number of suitable ways.

For example, the composition of the electrolytic solution, the raw materials used for production, the production method, the production conditions, the characteristics of the electrolytic solution, the electrochemical device, and the configuration or structure of the battery described above are examples, and the present application is not limited thereto these, and can be changed appropriately. A mixture of the electrolytic solution and an organic polymer (for example, polyethylene oxide, polyacrylonitrile, and/or polyvinylidene fluoride (PVdF)) may also be used as a gel electrolyte.

### EXAMPLES

Examples of the present disclosure are provided below according to an embodiment.

### Example A1

### (Materials)

MgCl₂ (anhydride): manufactured by Sigma-Aldrich Co. LLC.
MgTFSI2 (magnesium bistrifluoromethanesulfonylimide): manufactured by Tomiyama Pure Chemical Industries, Ltd.
Dimethoxyethane (DME): manufactured by Tomiyama Pure Chemical Industries, Ltd.
Diethylene glycol dimethyl ether (G2): manufactured by Tomiyama Pure Chemical Industries, Ltd.
Sulfur crystal (S): Wako Pure Chemical Industries, Ltd.
Acetylene black (AB): Denka black (DB): manufactured by Denka Company Limited (specific surface area: 68 m²/g)
Ketjen black (KB): manufactured by Lion Corporation (specific surface area: 1270 m²/g)
Styrene-butadiene rubber (SBR): manufactured by JSR Corporation
Carboxymethyl cellulose: manufactured by DKS Co. Ltd.
Mg plate (Purity: 99.9%, Thickness: 200 μm): manufactured by Rikazai Co., Ltd.
Glass fiber (GC50): manufactured by Advantec

### (Production of Sulfur Positive Electrode)

Sulfur and a carbon material were used at a weight ratio of 50:50.

As the carbon material, Denka black and Ketjen black were used at a weight ratio of 50:50.

Sulfur and Denka black were weighed so as to have a predetermined weight ratio, and dry-mixed using an agate mortar. Ketjen black was weighed and added thereto so as to have a predetermined weight ratio, and dry-mixing was performed in an agate mortar to obtain a carbon-sulfur composite. The carbon-sulfur composite, styrene butadiene rubber, and carboxymethyl cellulose were added to a mixed solution of water/methanol at a volume ratio of 10:90, and mixed with a pencil mixer to prepare a positive electrode slurry (solid content: 20 wt %). The total amount of styrene butadiene rubber and carboxymethylcellulose was 1 wt % based on the carbon-sulfur composite, and the weight ratio of styrene butadiene rubber and carboxymethylcellulose was 1: The positive electrode slurry was applied onto a SUS 304 foil using a bar coater, and subjected to vacuum drying at 40° C. for 12 hours and normal pressure drying at 80° C. for minutes to prepare a positive electrode sheet (formation of a positive electrode layer). This was punched out so as to have a diameter of 15 mm to obtain a sulfur positive electrode.

### (Production of Coin Battery)

A coin battery of a magnesium-sulfur secondary battery was produced according to the following specifications.
Positive electrode: Sulfur positive electrode
Negative electrode: Mg plate having a diameter of 16 mm and thickness of 200 μm/purity 99.9%, (magnesium plate manufactured by Rikazai Co., Ltd)
Electrolytic solution
Magnesium salt: Halogen metal salt (MgCl₂ (anhydride): manufactured by Sigma-Aldrich Co. LLC, product number 449172, 0.8 M) and imide metal salt (Mg(TFSI)₂: manufactured by Tomiyama Pure Chemical Industries, Ltd., product number MGTFSI, 0.8 M)
Linear ether solvent: Diethylene glycol dimethyl ether (super-dehydrated product), (Tomiyama Pure Chemical Industries, Ltd., product number G2)
Separator: Glass fiber (glass fiber, product number GC50) manufactured by ADVANTEC
Form of secondary battery: Coin battery CR2016 type

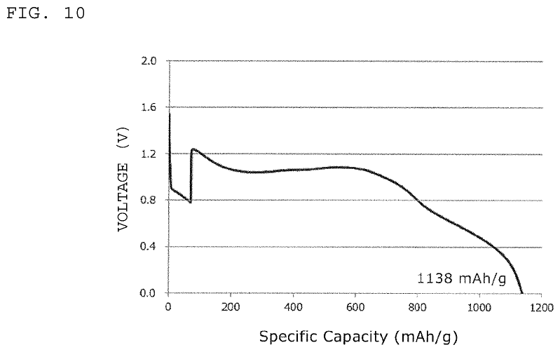

Specifically, a coin battery was produced by the following method. FIG. 9 illustrates a schematic developed view of a produced battery.

A gasket 22 was placed on a coin battery can 21, on which a sulfur positive electrode 23, a glass fiber separator 24, a negative electrode 25, a spacer 26 including a 0.5-mm-thick stainless-steel plate, and a coin battery lid 27 were stacked in this order and then sealed inside by crimping the coin battery can 21. The spacer 26 was spot-welded to the coin battery lid 27 in advance. The electrolytic solution was used in the form of being contained in the separator 24 of a coin battery 20.

### (Measurement of Discharging Capacity)

The produced battery was subjected to charging, and discharging capacity was measured. The measurement results are illustrated in FIG. 10. The discharging conditions were as follows.

Discharge conditions: CC discharge 0.1 mA/0.6 V cutoff Temperature: 25° C.

In Example A2, Comparative Example A1, Examples B1 and B2, Comparative Example B1, Example C1, and Comparative Example C1 described later, the discharging capacity was measured by the same method as in Example A1.

The discharging capacity of examples was evaluated by the rate of increase from the discharging capacity of each comparative example.

The details are as follows.

The discharging capacity of Examples A1 and A2 was evaluated by the rate of increase from the discharging capacity of Comparative Example A1.

The discharging capacity of Examples B1 and B2 was evaluated by the rate of increase from the discharging capacity of Comparative Example B1.

The discharging capacity of Example C1 was evaluated by the rate of increase from the discharging capacity of Comparative Example C1.
⊙: 130%≤Rate of increase (best);
o; 110≤Rate of increase<130% (excellent);
x: Rate of increase<110% (problem in practical use).

### Example A2, Comparative Example A1, Examples B1 and B2, Comparative Example B1, Example C1, and Comparative Example C1

Production of a coin battery and measurement of a discharging capacity were performed in the same manner as in Example A1 except that the weight ratio of sulfur and the carbon material and the weight ratio of Denka Black and Ketjen Black were changed to the ratios shown in the table.

The positive electrode layer in the positive electrode obtained in Example A1 and Comparative Example A1 was subjected to EDS mapping (2500 times) of sulfur element.

In the positive electrode layer of Example A1, the sulfur element was sufficiently uniformly dispersed.

In the positive electrode layer of Comparative Example A1, the sulfur element was aggregated and not uniformly dispersed.

TABLE 1

| | | | Carbon material | | Discharging | |
|---|---|---|---|---|---|---|
| | Positive electrode | | (weight ratio) | | capacity | |
| | layer (weight | | Low | High | (energy density) | |
| | ratio) | | specific | specific | | Rate |
| | | Carbon | surface | surface | Value | of increase |
| | Sulfur | material | area | area | (mAh/g) | (%) |
| Example A1 | 50 | 50 | 50 | 50 | 1138 | 232 [symbol] |
| Example A2 | 50 | 50 | 90 | 10 | 599 | 122 ◯ |
| Comparative | 50 | 50 | 100 | 0 | 491 | — |
| Example A1 | | | | | | |
| Example B1 | 70 | 30 | 50 | 50 | 541 | 147 [symbol] |
| Example B2 | 70 | 30 | 83 | 17 | 412 | 112 ◯ |
| Comparative | 70 | 30 | 100 | 0 | 368 | — |
| Example B1 | | | | | | |
| Example C1 | 90 | 10 | 50 | 50 | 388 | 156 [symbol] |
| Comparative | 90 | 10 | 100 | 0 | 248 | — |
| Example C1 | | | | | | |

The positive electrode of the present application can be used in various fields for extracting energy by utilizing an electrochemical reaction. Although it is merely an example, the positive electrode of the present application is used not only for secondary batteries but also for various electrochemical devices such as capacitors, air batteries and fuel cells. For example, the electrochemical device (particularly, a secondary battery, a capacitor, an air cell, and a fuel cell) including the positive electrode according to the present application can be used in the field of electronics mounting. The electrochemical device including a positive electrode according to an embodiment of the present application can also be used in the fields of electricity, information, and communication in which mobile equipment, and the like are used (for example, electric and electronic equipment fields or mobile equipment fields including mobile phones, smartphones, notebook computers and digital cameras, activity meters, arm computers, electronic papers, and small electronic machines such as wearable devices, RFID tags, card type electronic money, and smartwatches), home and small industrial applications (for example, the fields of electric tools, golf carts, and home, nursing, and industrial robots), large industrial applications (for example, fields of forklift, elevator, and harbor crane), transportation system fields (field of, for example, hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a research submarine), and the like.

### DESCRIPTION OF REFERENCE SYMBOLS

10: Positive electrode
11: Negative electrode
12: Electrolyte layer
20: Coin battery
21: Coin battery can
22: Gasket
23: Positive electrode
24: Separator
25: Negative electrode
26: Spacer
27: Coin battery lid
31: Positive electrode
32: Negative electrode
33: Separator
36: Current collector
37: Gasket
41: Porous positive electrode
42: Negative electrode
43: Separator and electrolytic solution
44: Air electrode-side current collector
45: Negative electrode-side current collector
46: Diffusion layer
47: Oxygen-selective permeable membrane
48: Exterior body
51: Air (atmosphere)
52: Oxygen
61: Positive electrode
62: Positive electrode electrolytic solution
63: Positive electrode electrolytic solution transport pump
64: Fuel flow path
65: Positive electrode electrolytic solution storage container
71: Negative electrode
72: Negative electrode electrolytic solution
73: Negative electrode electrolytic solution transport pump
74: Fuel flow path
75: Negative electrode electrolytic solution storage container
66: Ion-exchange membrane
100: Magnesium secondary battery
111: Electrode structure housing member (battery can)
112, 113: Insulating plate
114: Battery lid
115: Safety valve mechanism
115A: Disk plate
116: Positive temperature coefficient element (PTC element)
117: Gasket
118: Center pin
121: Electrode structure
122: Positive electrode
123: Positive electrode lead portion
124: Negative electrode
125: Negative electrode lead portion
126: Separator
200: Exterior member
201: Adhesive film
221: Electrode structure
223: Positive electrode lead portion
225: Negative electrode lead portion
1001: Cell (assembled battery)
1002: Magnesium secondary battery
1010: Control unit
1011: Memory
1012: Voltage measuring unit
1013: Current measuring unit
1014: Current detection resistor
1015: Temperature measuring unit
1016: Temperature detection element
1020: Switch control unit
1021: Switch unit
1022: Charge control switch
1024: Discharge control switch
1023, 1025: Diode
1031: Positive electrode terminal
1032: Negative electrode terminal CO, DO: Control signal
2000: Housing
2001: Control unit
2002: Various sensor
2003: Power source
2010: Engine
2011: Power generator
2012, 2013: Inverter
2014: Driving motor
2015: Differential device
2016: Transmission
2017: Clutch
2021: Front wheel drive shaft
2022: Front wheel
2023: Rear wheel drive shaft
2024: Rear wheel
3000: House
3001: Control unit
3002: Power source
3003: Smart meter
3004: Power hub
3010: Electrical device (electronic device)
3011: Electrically driven vehicle
3021: Private power generator
3022: Centralized electric power system
4000: Tool body
4001: Control unit
4002: Power source
4003: Drill unit

It should be understood that various changes and modifications to the embodiments described herein will be apparent to those skilled in the art. Such changes and modifications can be made without departing from the spirit and scoped of the present subject matter and without diminishing its intended advantages. It is therefore intended that such changes and modifications be covered by the appended claims.

1. A positive electrode comprising:
sulfur; and a carbon material,
wherein the carbon material includes a carbon black having a first specific surface area and a carbon black having a second specific surface area, and the first specific surface area is lower than the second specific surface area.

2. The positive electrode according to claim 1, wherein the first specific surface area is 30 m²/g or more and 200 m²/g or less, and
the second specific surface area is 800 m²/g or more and 1600 m²/g or less.

3. The positive electrode according to claim 1, wherein when the first specific surface area is denoted by SA (m²/g), and
the second specific surface area is 10×SA (m²/g) or more and 30×SA (m²/g) or less.

4. The positive electrode according to claim 1, wherein a content of the carbon black having the second specific surface area is 5 wt % or more and 75 wt % or less with respect to a total amount of the carbon black having the first specific surface area and the carbon black having the second specific surface area.

5. The positive electrode according to claim 1, wherein a content of the carbon black having the second specific surface area is 20 wt % or more and 50 wt % or less with respect to a total amount of the carbon black having the first specific surface area and the carbon black having the second specific surface area.

6. The positive electrode according to claim 1, wherein a content of the carbon material is 5 wt % or more and 70 wt % or less with respect to a total amount of the sulfur and the carbon material.

7. The positive electrode according to claim 1, wherein a content of the carbon material is 20 wt % or more and 60 wt % or less with respect to a total amount of the sulfur and the carbon material.

8. The positive electrode according to claim 1, wherein the positive electrode is used in an electrochemical device.

9. The positive electrode according to claim 8, wherein the electrochemical device is a magnesium-sulfur secondary battery.

10. An electrochemical device comprising:
the positive electrode according to claim 1.

11. The electrochemical device of claim 10, further comprising:
a solvent,
wherein the solvent includes an ether-based solvent.

12. The electrochemical device of claim 10, wherein the electrochemical device is a magnesium-sulfur secondary battery.
